(19) United States
(12) Patent Application Publication
(10) Pub. No.: US 2024/0378070 A1
(43) Pub. Date: Nov. 14, 2024

(54) ZERO-COPY CONCURRENT FILE SHARING PROTOCOL ACCESS FROM VIRTUAL MACHINE

(71) Applicant: Rubrik, Inc., Palo Alto, CA (US)

(72) Inventors: Udipta Das, Bengaluru (IN); Rohil Raj, Bengaluru (IN)

(21) Appl. No.: 18/195,242

(22) Filed: May 9, 2023

(51) Int. Cl. G06F 9/455; G06F 8/30

(52) U.S. Cl. CPC G06F 9/45558; G06F 8/311; G06F 2009/45583

(57) ABSTRACT

Methods, systems, and devices for data management are described. A data management system may implement one or more data management applications via a virtual machine. The virtual machine may allocate, using a first programming language, at least one memory buffer within system memory. The at least one memory buffer is accessible based at least in part on a library that is associated with a second programming language and that supports communication with a file system server. An interface may be generated for accessing, via the virtual machine, the at least one memory buffer. The interface may be associated with the first programming language that is also associated with the virtual machine. The virtual machine may perform, using the interface and the first programming language that is associated with the virtual machine, a zero-copy read of data from or a zero-copy write of data to the file system server.

### FIELD OF TECHNOLOGY

The present disclosure relates generally to data management, including techniques for zero-copy concurrent file sharing protocol access from a virtual machine.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports zero-copy concurrent file sharing protocol access from a virtual machine in accordance with aspects of the present disclosure.

FIG. 2 shows an example of a computing environment that supports zero-copy concurrent file sharing protocol access from a virtual machine in accordance with aspects of the present disclosure.

FIG. 3 shows an example of a process flow that supports zero-copy concurrent file sharing protocol access from a virtual machine in accordance with aspects of the present disclosure.

FIG. 4 shows a block diagram of an apparatus that supports zero-copy concurrent file sharing protocol access from a virtual machine in accordance with aspects of the present disclosure.

FIG. 5 shows a block diagram of a virtual machine manager that supports zero-copy concurrent file sharing protocol access from a virtual machine in accordance with aspects of the present disclosure.

FIG. 6 shows a diagram of a system including a device that supports zero-copy concurrent file sharing protocol access from a virtual machine in accordance with aspects of the present disclosure.

FIGS. 7 through 11 show flowcharts illustrating methods that support zero-copy concurrent file sharing protocol access from a virtual machine in accordance with aspects of the present disclosure.

### DETAILED DESCRIPTION

A host system may implement a network file share protocol such as Server Message Block (SMB) to share and receive host data. A data management system, which may function to backup, restore, and/or archive host data, may access host data via the file share protocol implemented by the host system. In some examples, the data management system may utilize services implemented via a Java Virtual Machine (JVM) to perform data management procedures. However, access to the SMB server by a client system (e.g., the data management system) may be conditioned on utilization of a C++ Library (e.g., the “libsmb2” library). However, as the virtual machine may be a JVM, the virtual machine may not support utilization of a C++ library. Thus, the virtual machine supporting one or more programming language (e.g., Java or Scala), while the file servers are configured for access using a library in another programming language (e.g., C++), presents a compatibility problem between the virtual machine and the file servers. Existing techniques for addressing such incompatibilities may cause issues such as input/output (I/O) freezes, node reboots, and/or may have latency issues.

Techniques described herein support virtual machine based access to a file system server using an interface that allows improved reliability and performance in reading from or writing to the file system server. Specifically, the techniques described herein support allocation, by a virtual machine that is associated with a first programming language, of one or more memory buffers within system memory (e.g., memory separate from memory allocated for use by the virtual machine). The one or more memory buffers may be accessed by the library associated with the second programming language and that is configured to access the file system server. An interface may be generated for accessing, by the virtual machine for the one or more memory buffers. The interface may be generated using the first programming language. The virtual machine may execute code based on the first programming language to perform, using the interface, a zero-copy read of data from or a zero-copy write of data to the file system server. As such, the techniques described herein support access, via a virtual machine, to a library configured to communicate with the file system service using zero-copy read or write techniques, which results in improved latency and reduced errors caused by other compatibility solutions. Techniques are described herein with respect to accessing file data for data protection, but it should be understood that these techniques may be applicable to other scenarios involving access to data via a server. These and other techniques are described in further detail with respect to the figures.

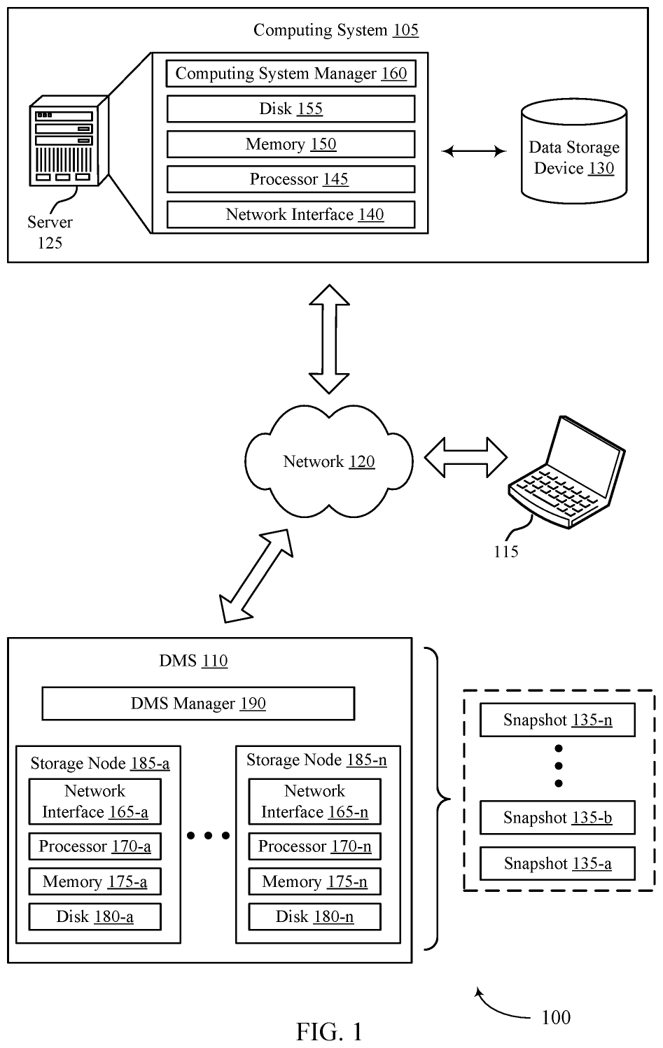

FIG. 1 illustrates an example of a computing environment 100 that supports zero-copy concurrent file sharing protocol access from a virtual machine in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

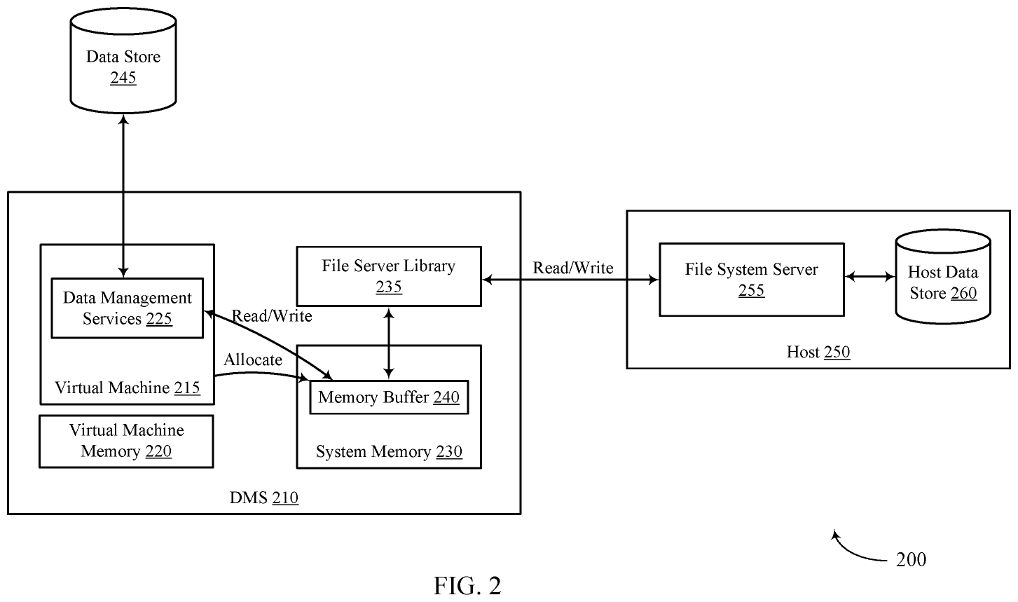

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185. In some examples, the storage nodes 185 utilize a file server library (e.g., a file server library 235 of FIG. 2) to access aspects of the computing system 105, such as the server 125. As described in further detail herein, the file server library may be a zero-copy library.

The DMS 110 may provide a backup and recovery service for the computing system 105. For example, the DMS 110 may manage the extraction and storage of snapshots 135 associated with different point-in-time versions of one or more target computing objects within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target computing objects within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more computing objects of the computing system 105, metadata for one or more computing objects of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some cases, the computing system 105 and/or the server 125 may implement a file sharing server to receive and/or provide access to data stored in the computing system 105, such as data in the data storage device 130. Thus, the DMS 110 may access the data of the computing system 105 via interfacing with the file system server. For example, the DMS 110 may access the computing system 105 via the file system server in order to read host data for snapshot or backup services, as described herein. Additionally, or alternatively, the DMS 210 may access the computing system 105 via the file system server to write data to support a restore, recovery, or archival service, as described herein. As noted, the techniques described herein may be applicable to any operation or scenario that utilizes the data of the computing system 105.

In some examples, a client, such as the DMS 110, may utilize or implement a library in order to communicate with the file system server implemented by the computing system 105. Various services (e.g., snapshot, backup, archival, recovery services) may be implemented by the DMS 110 using a virtual machine, such as a Java Virtual Machine (JVM). That is, these services may be configured using a first programming language (e.g., Java or Scala) that is compiled and executed by the JVM. However, the library that is used to access the file system server of the computing system 105 may be implemented by a second programming language that is incompatible with the JVM (e.g., C++). Various solutions to address such incompatibilities have been used, but such solutions may include performance bottlenecks and may result in issues, such as I/O freeze-ups, node reboots, bugs, etc.

Techniques described herein address these compatibilities while reducing or limiting such bottlenecks or issues. For example, the virtual machine on the DMS 110 may execute instructions to allocate at least one memory buffer within system memory (e.g., memory separate from the memory heap associated with the JVM) and generate an interface to access the least one memory buffer. The virtual machine may further perform a zero-copy read of data from or a zero-copy write of data to the file system server (e.g., the server 125) of the computing system 105 using the interface and the at least one memory buffer. As the memory buffer and the corresponding interface support zero-copy reads and writes, performance hits resulting from copying data from one memory location to another may not be present.

FIG. 2 shows an example of a computing environment 200 that supports zero-copy concurrent file sharing protocol access from a virtual machine in accordance with aspects of the present disclosure. The computing environment 200 includes a DMS 210 and a host 250. The DMS 210 may be an example of a DMS 110 as described with respect to FIG. 1, and the host 250 may be an example of aspects of the computing system 105 of FIG. 1. For example, the DMS 210 may provide data management services 225, such as backup, recovery, and/or archival services for data managed at the host 250, such as data of host data store 260. The host 250 may support various client facing applications, such as a database server, application server, web server, enterprise applications, or the like, that use data from the host data store 260.

The DMS 210 may use one or more communication protocols to access data of the host data store 260 for data management services 225. For example, the host 250 may utilize a file system server 255 to share data of the host data store 260 over a network, and as such, the DMS 210 may access the data using the file system protocol. For example, the file system may be a Windows® file system, and the data may be accessed via the SMB protocol. In some cases, the data is accessed via a kernel based network file system, such as a Linux common internet file system (CIFS) module or via concurrent streams. However, these solutions may result in performance bottlenecks or issues, such as I/O freezes, node reboots, or bugs in the CIFS module.

Techniques described herein address these issues via multiple concurrent SMB streams (in either direction) with zero copies from the business logic (e.g., the data management services 225) inside a virtual machine 215 (e.g., JVM). For example, the techniques may support zero-copy read/writes up to direct memory access (DMA) to or from a network card. The techniques are described herein with respect to accessing the file system server 255 in support of data management techniques (e.g., data management services 225), but it should be understood that these techniques may be applicable in other scenarios involving accessing files and folders from a Windows SMB share from inside a virtual machine. In some cases, however, since access for data protection may be sequential in nature, the benefits of these techniques described herein may be accentuated. Further, the described techniques may be implemented in various programming languages supported by the virtual machine 215, such as via Java and Scala executable via the JVM. The approach described herein utilizes a zero-copy from data buffers of an output stream of the virtual machine 215 (e.g., JVM OutputStream) to the direct memory access (DMA) read of the network interface card (NIC) send in the write path, and from the DMA memory write in the NIC receive up to the input stream (e.g., JVM InputStream) inside the JVM read path. Further, the solution may support multiple concurrent streams without utilization of serialization in the data path. I/Os to unrelated extents of the SMB exported files may happen concurrently. For concurrent I/O to/from the same extents, locking may occur from the SMB server side (e.g., from the file system server 255).

A file server library 235 may be used to access the file system server 255, and the file server library 235 may be implemented via a programming language that is incompatible with the virtual machine 215. For example, the data management services 225 may be implemented in Java or Scala such as to be compiled and executed by the virtual machine 215 (e.g., JVM), but the file server library 235 may be a library implemented in C++ (e.g., the file server library 235 is a libsmb2 library). The C++ library may be used by services to perform DMS techniques, such as data snapshotting. However, such services may utilize data paths from the virtual machine 215 to communicate various objects, including external services (e.g., cloud vendors). As such, an interface from inside the virtual machine 215 may be used to communicate with the file system server 255 (e.g., SMBv3 server). Additionally, for performance, the techniques described herein support a zero-copy implementation of such an interface without serialization of the data path for concurrent I/O.

To access the file server library 235 from inside the virtual machine 215, a binding (e.g., a way to access to library/functionality in one language from another language) or interface may be implemented. For example, a Java Native Interface (JNI) may function as a bridge from the virtual machine 215 to the file server library 235. In order to preserve the zero-copy semantics of the file server library 235, a buffer interface (e.g., Java New or Non-blocking I/O (NIO) ByteBuffer interface) is used to manage buffers in JVM native memory (e.g., system memory outside the Java heap) which may be directly accessible by and addressable from the file server library 235.

More particularly, a JVM is typically executed in a protected environment (e.g., resources are allocated for use by the JVM). Thus, when the JVM allocates memory, it may allocate memory from the heap used for the JVM (e.g., virtual machine memory 220)). However, in order to support the zero-copy techniques described herein, a technique to address and use memory without copying the data of the memory from outside the JVM to inside the JVM (or vice versa) is used. The JAVA NIO ByteBuffer interfaces support management of such native memory (outside the heap or system memory or virtual machine memory 220) without copying data between native and heap memory (e.g., between the virtual machine memory 220 and the system memory 230). That is, the JNI supports the allocation of buffers in the native memory (OS memory or system memory 230) and outside the virtual machine memory 220, which is accessible via the file server library 235. The Java NIO ByteBuffer interface allows the file server library 235 to write data to or read data from the allocated buffers (e.g., memory buffer 240) in support of file transfer to or from the file system server 255 (in a zero-copy manner). Further, the Java NIO ByteBuffers allow other applications, such as data mange services 225, to treat the native memory (e.g., the memory buffers 240) in the system memory 230) as a Java or Scala construct (e.g., a construct supported by the virtual machine 215).

Further, as some data management services 225, such as an archival service, may utilize Java streams, these techniques support a zero-copy mechanism for exporting buffers (e.g., memory buffer 240) received by the file server library 235. For example, the utilization of custom iterators may support export of the buffers received by the file server library 235. Additionally, the techniques support access to multiple file system servers 255 via multiple connections. To support multiple connections, the file server library 235 (e.g., implemented in C++) may be used to maintain the memory map of the connections to the file system server 255, and keys (identifiers) to the maps may be passed to and used by the virtual machine 215 to address the connections. Similarly, concurrent access to multiple files or directories in the same server may be achieved via a map configured via the file server library 235 and accessed via the virtual machine 215 by passing keys to the mapping to the virtual machine 215. This technique allows connections to be created in the file server library 235, cached in the corresponding memory of the file server library 235 (e.g., system memory), and the keys (e.g., identifiers or pointers) to the cache are passed to and used by the virtual machine 215 using the techniques described herein. For concurrent access to multiple files, a respective ByteBuffer (e.g., memory buffer 240) and a respective iterator is created for each file, and the ByteBuffer and the iterator is used to push data to or pull data from the file.

Thus, techniques described herein support virtual machine based access to a SMB server using an interface that allows improved reliability and performance in reading from or writing to the SMB server. The utilization of the JNI allows “native” code of a different programming language (e.g., the C++ code that implements the library libsmb2 for SMB-based access) to be compiled separately from the Java or Scala code executed by the virtual machine 215 (e.g., the virtual machine is a JVM), and the bytecode (compiled Java or Scala code) can cause execution of the native code. Further, the techniques described herein support the utilization of a buffer that is within system memory and allocated by the virtual machine for access by the file system server 255. The Java NIO library, and more specifically a Java NIO ByteBuffer interface, may be used to interface with the buffer allocated for access by the SMB server. The Java NIO ByteBuffer allows for the data to be read by the SMB server or written by the SMB server, and accessed by the JVM, in a zero-copy manner (e.g., no copying data from one memory location to another memory location), which improves processor and memory performance. Further, as the interface is implemented in the JVM, other applications, such as an archival application, may access the data using typical Java or Scala implemented techniques. Accordingly, using these techniques, a pure Java Streams interface may be configured and may be used to expose both read and write interfaces to SMBv3 compatible servers without a kernel footprint, which may result in high throughput and low latency through concurrent access and zero-copy transfers between the business logic and the network DMA.

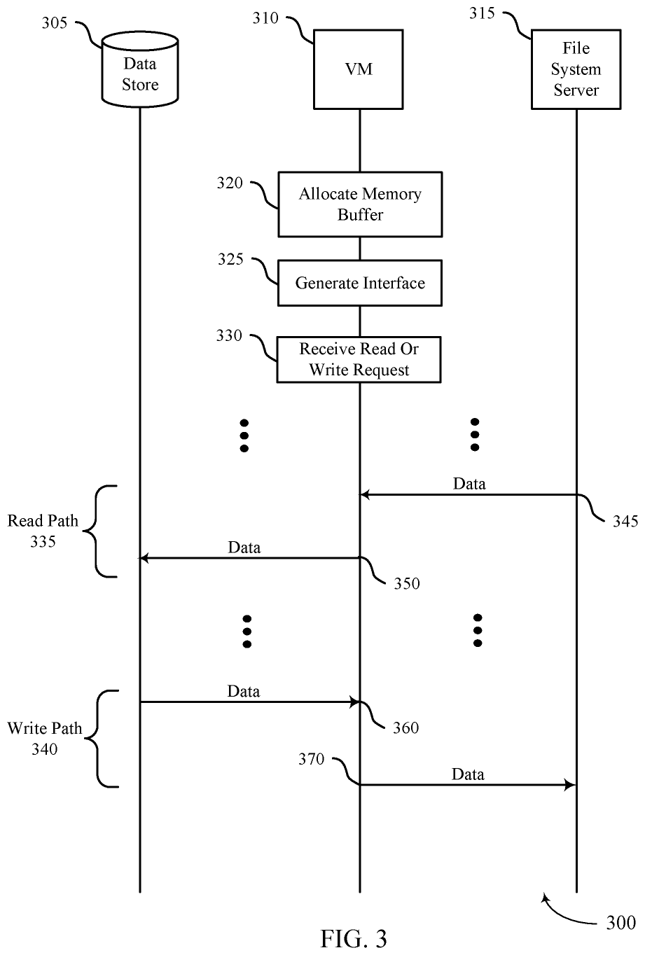

FIG. 3 shows an example of a process flow 300 that supports zero-copy concurrent file sharing protocol access from a virtual machine in accordance with aspects of the present disclosure. The process flow 300 includes a data store 305, a virtual machine 310, and a file system server 315. The data store 305 may be an example of a data store associated with, accessed by, or managed by a DMS, such as DMS 110 of FIG. 1. For example, the data store 305 may be an example of the data store 245 of FIG. 2. The virtual machine 310 may be an example of a virtual machine (e.g., JVM), as described herein, such as virtual machine 215 of FIG. 2. The file system server 315 may be an example of the file system server 255 of FIG. 2, and may be implemented by a server host, such as host 250 or computing system 105. In the following description of the process flow 300, the operations between aspects of the process flow may be transmitted in a different order than the example order shown, or the operations performed may be performed in different orders or at different times. Some operations may also be omitted from the process flow 300, and other operations may be added to the process flow 300.

At 320, the virtual machine 310 may allocate, using a virtual machine associated with a first programming language, at least one memory buffer within system memory. The at least one memory buffer may be associated with a second programming language, and the at least one memory buffer may be accessible based at least in part on a library that is associated with the second programming language and that supports communication with a file system server. In some examples, the first programming language is Java or Scala and the second programming language is C++. Additionally, the at least one memory buffer may be configured to be accessed by the file system server based at least in part on a SMB protocol. In some examples, allocation of the at least one memory buffer includes identifying a respective key corresponding to each memory buffer of the at least one memory buffer, and a key is used to address, by the virtual machine, a corresponding memory buffer for a zero-copy read or a zero-copy write. In some cases, each key is mapped to a respective file system server of a plurality of file system servers or a file or directory of the file system server 315. The at least one memory buffer may be allocated (e.g., using the first programming language, outside a memory heap associated with the virtual machine. That is, the at least one memory may be allocated in native memory or system memory.

At 325, the virtual machine 310 may generate an interface for accessing, via the virtual machine, the at least one memory buffer. The interface may be associated with (e.g., generated using) the first programming language that is also associated with the virtual machine. In some examples, the interface is generated using a library (e.g., a Java NIO ByteBuffer library).

At 330, the virtual machine 310 may receive a read or write request from a data management application. In such cases, the interface supports a data path to the at least one memory buffer for the data management application. For example, the data management application may call or execute a function that results in the read or write request. The data management application may be an example of an archival application.

At 335, operations for a read from the file system server are illustrated, and at 340, operations of a write to the file system server are illustrated. The operations at 335 and at 340 may be performed concurrently or at different times and may be performed with the same or with different file system servers, but only one file system server is shown for illustrative purposes.

At 345, in accordance with the zero-copy read, data of the file system server 315 may be written to the at least one memory buffer by the file system server 315 (e.g., using the library). Thus, the at least one memory buffer is configured to accept the data from the file system server. At 350, the virtual machine 310 may read, in accordance with the zero-copy read, the data from the at least one memory buffer without copying the data to another memory location. The read data may be written (e.g., using the data management application) to the data store 305, such as for archival of the data.

At 360, in accordance with the zero-copy write, data may be written (e.g., from the data store 305) to the at least one memory buffer without copying the data to another memory location. The at least one memory buffer may be configured to make the data available to the file system server (e.g., using the library implemented using the second programming language) after the data is written to the at least one memory buffer. At 370, the data may be read from the at least memory buffer by the file server library and passed to the file system server 315.

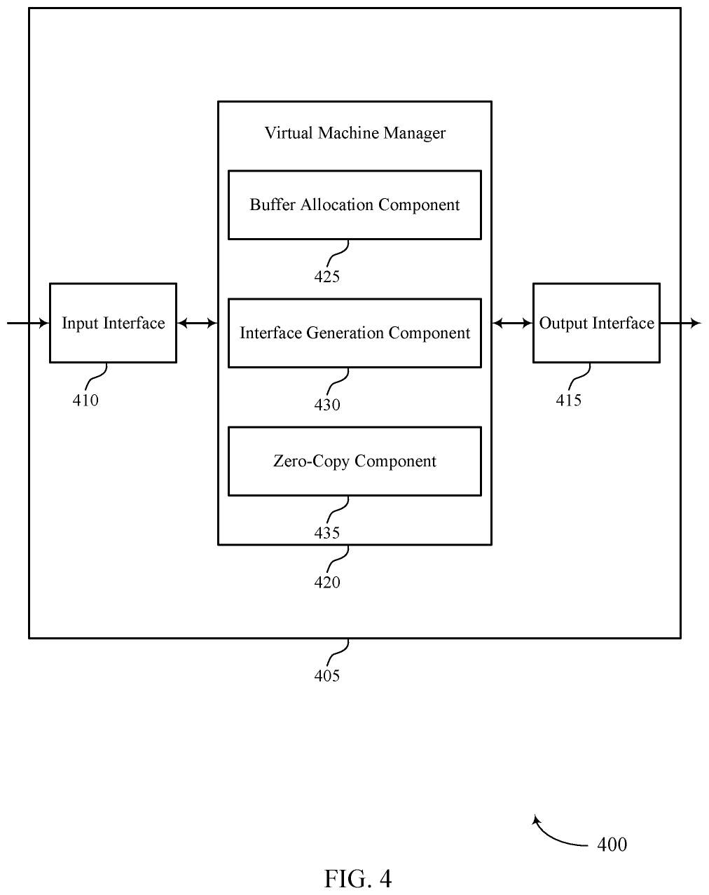

FIG. 4 shows a block diagram 400 of a system 405 that supports zero-copy concurrent file sharing protocol access from a virtual machine in accordance with aspects of the present disclosure. In some examples, the system 405 may be an example of aspects of one or more components described with reference to FIG. 1, such as a DMS 110. The system 405 may include an input interface 410, an output interface 415, and a virtual machine manager 420. The system 405 may also include one or more processors. Each of these components may be in communication with one another (e.g., via one or more buses, communications links, communications interfaces, or any combination thereof).

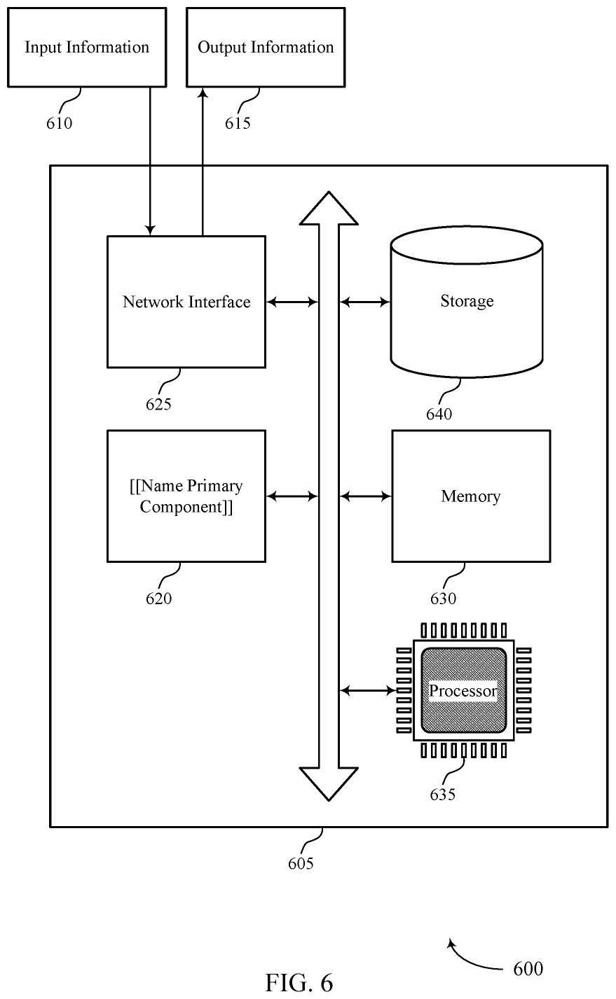

The input interface 410 may manage input signaling for the system 405. For example, the input interface 410 may receive input signaling (e.g., messages, packets, data, instructions, commands, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the virtual machine manager 420 to support zero-copy concurrent file sharing protocol access from a virtual machine. In some cases, the input interface 410 may be a component of a network interface 625 as described with reference to FIG. 6.

The output interface 415 may manage output signaling for the system 405. For example, the output interface 415 may receive signaling from other components of the system 405, such as the virtual machine manager 420, and may transmit such output signaling corresponding to (e.g., representative of or otherwise based on) such signaling to other systems or devices. In some cases, the output interface 415 may be a component of a network interface 625 as described with reference to FIG. 6.

For example, the virtual machine manager 420 may include a buffer allocation component 425, an interface generation component 430, a zero-copy component 435, or any combination thereof. In some examples, the virtual machine manager 420, or various components thereof, may be configured to perform various operations (e.g., receiving, monitoring. transmitting) using or otherwise in cooperation with the input interface 410, the output interface 415, or both. For example, the virtual machine manager 420 may receive information from the input interface 410, send information to the output interface 415, or be integrated in combination with the input interface 410, the output interface 415, or both to receive information, transmit information, or perform various other operations as described herein.

The virtual machine manager 420 may support data management in accordance with examples as disclosed herein. The buffer allocation component 425 may be configured as or otherwise support a means for allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server. The interface generation component 430 may be configured as or otherwise support a means for generating an interface for accessing, via the virtual machine, the at least one memory buffer, the interface associated with the first programming language that is also associated with the virtual machine. The zero-copy component 435 may be configured as or otherwise support a means for performing, using the interface and the first programming language that is associated with the virtual machine, a zero-copy read of data from or a zero-copy write of data to the file system server that is associated with the second programming language.

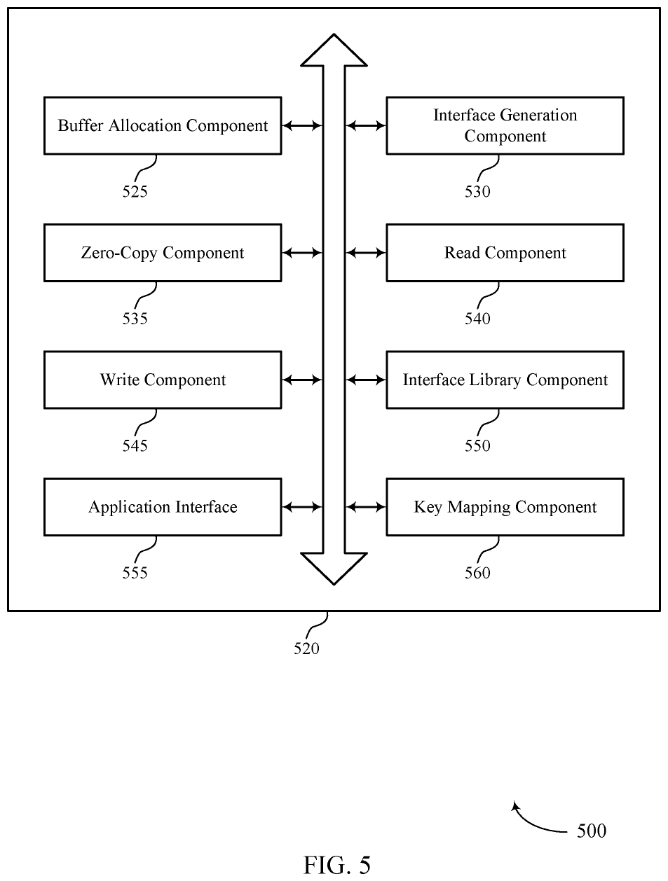

FIG. 5 shows a block diagram 500 of a virtual machine manager 520 that supports zero-copy concurrent file sharing protocol access from a virtual machine in accordance with aspects of the present disclosure. The virtual machine manager 520 may be an example of aspects of a virtual machine manager or a virtual machine manager 420, or both, as described herein. The virtual machine manager 520, or various components thereof, may be an example of means for performing various aspects of zero-copy concurrent file sharing protocol access from a virtual machine as described herein. For example, the virtual machine manager 520) may include a buffer allocation component 525, an interface generation component 530, a zero-copy component 535, a read component 540, a write component 545, an interface library component 550), an application interface 555, a key mapping component 560, or any combination thereof. Each of these components may communicate, directly or indirectly, with one another (e.g., via one or more buses, communications links, communications interfaces, or any combination thereof).

The virtual machine manager 520) may support data management in accordance with examples as disclosed herein. The buffer allocation component 525 may be configured as or otherwise support a means for allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server. The interface generation component 530 may be configured as or otherwise support a means for generating an interface for accessing, via the virtual machine, the at least one memory buffer, the interface associated with the first programming language that is also associated with the virtual machine. The zero-copy component 535 may be configured as or otherwise support a means for performing, using the interface and the first programming language that is associated with the virtual machine, a zero-copy read of data from or a zero-copy write of data to the file system server that is associated with the second programming language.

In some examples, to support performing the zero-copy read or the zero-copy write, the read component 540 may be configured as or otherwise support a means for reading, in accordance with the zero-copy read and via the virtual machine, the data from the at least one memory buffer without copying the data to another memory location, where the at least one memory buffer is configured to accept the data from the file system server before the data is read from the at least one memory buffer.

In some examples, to support performing the zero-copy read or the zero-copy write, the write component 545 may be configured as or otherwise support a means for writing, in accordance with the zero-copy write and via the virtual machine, the data to the at least one memory buffer without copying the data to another memory location, where the at least one memory buffer is configured to make the data available to the file system server after the data is written to the at least one memory buffer.

In some examples, to support generating the interface, the interface library component 550) may be configured as or otherwise support a means for generating the interface using a library associated with the first programming language, the interface being accessible via memory associated with the virtual machine.

In some examples, to support allocating the at least one memory buffer, the buffer allocation component 525 may be configured as or otherwise support a means for allocating, using the first programming language, the at least one memory buffer outside a memory heap associated with the virtual machine.

In some examples, to support performing the zero-copy read or the zero-copy write, the application interface 555 may be configured as or otherwise support a means for performing the zero-copy read or the zero-copy write based on a request received from a data management application, where the interface supports a data path to the at least one memory buffer for the data management application. In some examples, the data management application is an archival application.

In some examples, to support allocating the at least one memory buffer, the key mapping component 560 may be configured as or otherwise support a means for identifying a respective key corresponding to each memory buffer of the at least one memory buffer, where a key is used to address, by the virtual machine, a corresponding memory buffer for the zero-copy read or the zero-copy write.

In some examples, each key is mapped to a respective file system server of a set of multiple file system servers. In some examples, the first programming language is Java or Scala and the second programming language is C++. In some examples, the virtual machine is a Java virtual machine. In some examples, the at least one memory buffer is configured to be accessed by the file system server based on a server message block (SMB) protocol.

FIG. 6 shows a block diagram 600 of a system 605 that supports zero-copy concurrent file sharing protocol access from a virtual machine in accordance with aspects of the present disclosure. The system 605 may be an example of or include the components of a system 405 as described herein. The system 605 may include components for data management, including components such as a virtual machine manager 620, an input information 610, an output information 615, a network interface 625, a memory 630, a processor 635, and a storage 640. These components may be in electronic communication or otherwise coupled with each other (e.g., operatively, communicatively, functionally, electronically, electrically; via one or more buses, communications links, communications interfaces, or any combination thereof). Additionally, the components of the system 605 may include corresponding physical components or may be implemented as corresponding virtual components (e.g., components of one or more virtual machines). In some examples, the system 605 may be an example of aspects of one or more components described with reference to FIG. 1, such as a DMS 110.

The network interface 625 may enable the system 605 to exchange information (e.g., input information 610), output information 615, or both) with other systems or devices (not shown). For example, the network interface 625 may enable the system 605 to connect to a network (e.g., a network 120 as described herein). The network interface 625 may include one or more wireless network interfaces, one or more wired network interfaces, or any combination thereof. In some examples, the network interface 625 may be an example of may be an example of aspects of one or more components described with reference to FIG. 1, such as one or more network interfaces 165.

Memory 630 may include RAM, ROM, or both. The memory 630 may store computer-readable, computer-executable software including instructions that, when executed, cause the processor 635 to perform various functions described herein. In some cases, the memory 630 may contain, among other things, a basic input/output system (BIOS), which may control basic hardware or software operation such as the interaction with peripheral components or devices. In some cases, the memory 630 may be an example of aspects of one or more components described with reference to FIG. 1, such as one or more memories 175.

The processor 635 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 635 may be configured to execute computer-readable instructions stored in a memory 630 to perform various functions (e.g., functions or tasks supporting zero-copy concurrent file sharing protocol access from a virtual machine). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. In some cases, the processor 635 may be an example of aspects of one or more components described with reference to FIG. 1, such as one or more processors 170.

Storage 640) may be configured to store data that is generated, processed, stored, or otherwise used by the system 605. In some cases, the storage 640 may include one or more HDDs, one or more SDDs, or both. In some examples, the storage 640 may be an example of a single database, a distributed database, multiple distributed databases, a data store, a data lake, or an emergency backup database. In some examples, the storage 640 may be an example of one or more components described with reference to FIG. 1, such as one or more network disks 180.

The virtual machine manager 620 may support data management in accordance with examples as disclosed herein. For example, the virtual machine manager 620 may be configured as or otherwise support a means for allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server. The virtual machine manager 620 may be configured as or otherwise support a means for generating an interface for accessing, via the virtual machine, the at least one memory buffer, the interface associated with the first programming language that is also associated with the virtual machine. The virtual machine manager 620 may be configured as or otherwise support a means for performing, using the interface and the first programming language that is associated with the virtual machine, a zero-copy read of data from or a zero-copy write of data to the file system server that is associated with the second programming language.

By including or configuring the virtual machine manager 620 in accordance with examples as described herein, the system 605 may support techniques for zero-copy concurrent file sharing protocol access from a virtual machine, which may provide one or more benefits such as, for example, improved latency and reduced errors when performing reads from or writes to a file system server via a virtual machine, among other possibilities.

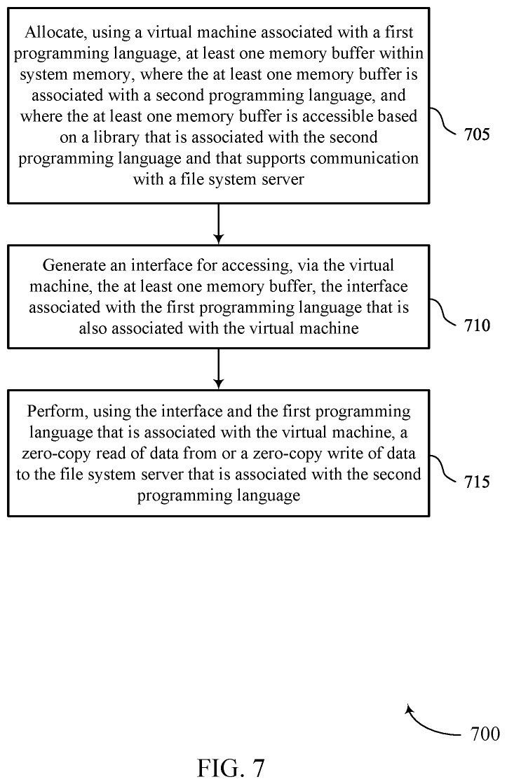

FIG. 7 shows a flowchart illustrating a method 700 that supports zero-copy concurrent file sharing protocol access from a virtual machine in accordance with aspects of the present disclosure. The operations of the method 700 may be implemented by a DMS or its components as described herein. For example, the operations of the method 700 may be performed by a DMS as described with reference to FIGS. 1 through 6. In some examples, a DMS may execute a set of instructions to control the functional elements of the wireless DMS to perform the described functions. Additionally, or alternatively, the wireless DMS may perform aspects of the described functions using special-purpose hardware.

At 705, the method may include allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server. The operations of 705 may be performed in accordance with examples as disclosed herein. In some examples, aspects of the operations of 705 may be performed by a buffer allocation component 525 as described with reference to FIG. 5.

At 710, the method may include generating an interface for accessing, via the virtual machine, the at least one memory buffer, the interface associated with the first programming language that is also associated with the virtual machine. The operations of 710 may be performed in accordance with examples as disclosed herein. In some examples, aspects of the operations of 710 may be performed by an interface generation component 530 as described with reference to FIG. 5.

At 715, the method may include performing, using the interface and the first programming language that is associated with the virtual machine, a zero-copy read of data from or a zero-copy write of data to the file system server that is associated with the second programming language. The operations of 715 may be performed in accordance with examples as disclosed herein. In some examples, aspects of the operations of 715 may be performed by a zero-copy component 535 as described with reference to FIG. 5.

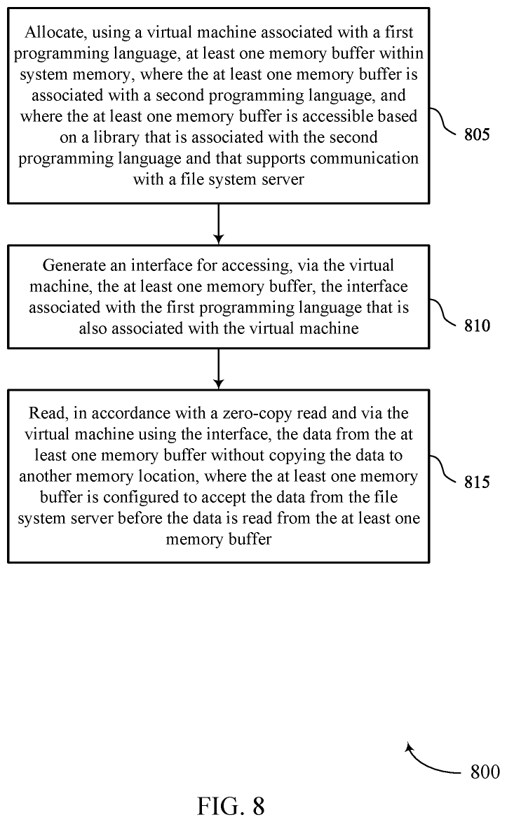

FIG. 8 shows a flowchart illustrating a method 800 that supports zero-copy concurrent file sharing protocol access from a virtual machine in accordance with aspects of the present disclosure. The operations of the method 800 may be implemented by a DMS or its components as described herein. For example, the operations of the method 800 may be performed by a DMS as described with reference to FIGS. 1 through 6. In some examples, a DMS may execute a set of instructions to control the functional elements of the wireless DMS to perform the described functions. Additionally, or alternatively, the wireless DMS may perform aspects of the described functions using special-purpose hardware.

At 805, the method may include allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server. The operations of 805 may be performed in accordance with examples as disclosed herein. In some examples, aspects of the operations of 805 may be performed by a buffer allocation component 525 as described with reference to FIG. 5.

At 810, the method may include generating an interface for accessing, via the virtual machine, the at least one memory buffer, the interface associated with the first programming language that is also associated with the virtual machine. The operations of 810 may be performed in accordance with examples as disclosed herein. In some examples, aspects of the operations of 810 may be performed by an interface generation component 530 as described with reference to FIG. 5.

At 815, the method may include performing, using the interface and the first programming language that is associated with the virtual machine, a zero-copy read of data from or a zero-copy write of data to the file system server that is associated with the second programming language. For example, the method includes reading, in accordance with a zero-copy read and via the virtual machine using the interface, the data from the at least one memory buffer without copying the data to another memory location, where the at least one memory buffer is configured to accept the data from the file system server before the data is read from the at least one memory buffer. The operations of 815 may be performed in accordance with examples as disclosed herein. In some examples, aspects of the operations of 815 may be performed by a zero-copy component 535 as described with reference to FIG. 5.

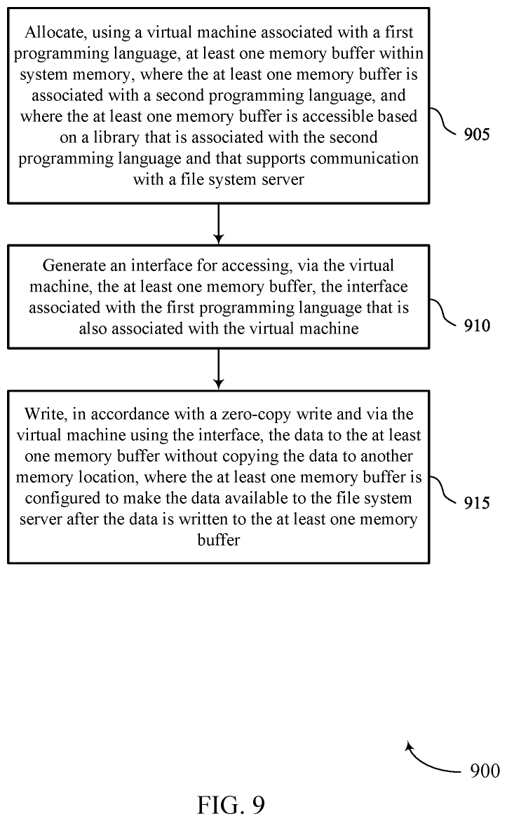

FIG. 9 shows a flowchart illustrating a method 900 that supports zero-copy concurrent file sharing protocol access from a virtual machine in accordance with aspects of the present disclosure. The operations of the method 900 may be implemented by a DMS or its components as described herein. For example, the operations of the method 900 may be performed by a DMS as described with reference to FIGS. 1 through 6. In some examples, a DMS may execute a set of instructions to control the functional elements of the wireless DMS to perform the described functions. Additionally, or alternatively, the wireless DMS may perform aspects of the described functions using special-purpose hardware.

At 905, the method may include allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server. The operations of 905 may be performed in accordance with examples as disclosed herein. In some examples, aspects of the operations of 905 may be performed by a buffer allocation component 525 as described with reference to FIG. 5.

At 910, the method may include generating an interface for accessing, via the virtual machine, the at least one memory buffer, the interface associated with the first programming language that is also associated with the virtual machine. The operations of 910 may be performed in accordance with examples as disclosed herein. In some examples, aspects of the operations of 910 may be performed by an interface generation component 530 as described with reference to FIG. 5.

At 915, the method may include performing, using the interface and the first programming language that is associated with the virtual machine, a zero-copy read of data from or a zero-copy write of data to the file system server that is associated with the second programming language. For example, the method may include writing, in accordance with a zero-copy write and via the virtual machine using the interface, the data to the at least one memory buffer without copying the data to another memory location, where the at least one memory buffer is configured to make the data available to the file system server after the data is written to the at least one memory buffer. The operations of 915 may be performed in accordance with examples as disclosed herein. In some examples, aspects of the operations of 915 may be performed by a zero-copy component 535 as described with reference to FIG. 5.

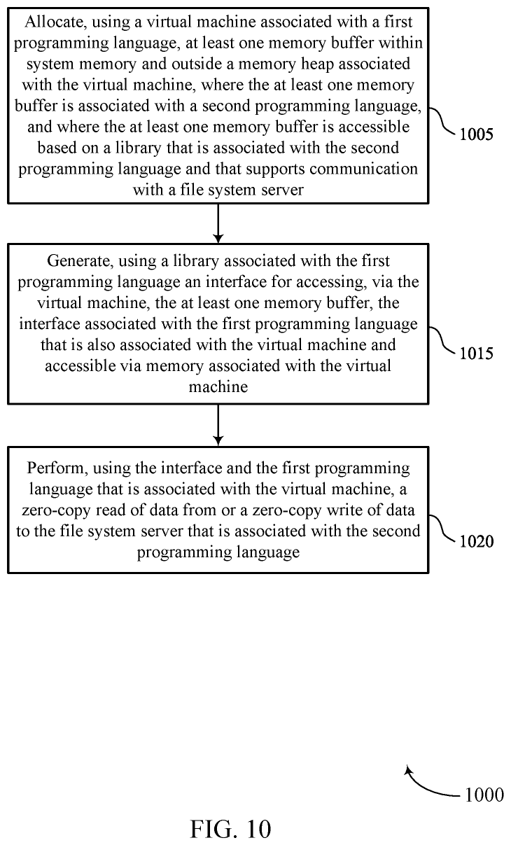

FIG. 10 shows a flowchart illustrating a method 1000 that supports zero-copy concurrent file sharing protocol access from a virtual machine in accordance with aspects of the present disclosure. The operations of the method 1000 may be implemented by a DMS or its components as described herein. For example, the operations of the method 1000 may be performed by a DMS as described with reference to FIGS. 1 through 6. In some examples, a DMS may execute a set of instructions to control the functional elements of the wireless DMS to perform the described functions. Additionally, or alternatively, the wireless DMS may perform aspects of the described functions using special-purpose hardware.

At 1005, the method may include allocating, using a virtual machine associated with a first programming language, at least one memory buffer within system memory and outside a memory heap associated with the virtual machine, where the at least one memory buffer is associated with a second programming language, and where the at least one memory buffer is accessible based on a library that is associated with the second programming language and that supports communication with a file system server. The operations of 1005 may be performed in accordance with examples as disclosed herein. In some examples, aspects of the operations of 1005 may be performed by a buffer allocation component 525 as described with reference to FIG. 5.

At 1010, the method may include allocating, using the first programming language, the at least one memory buffer outside a memory heap associated with the virtual machine. The operations of 1010 may be performed in accordance with examples as disclosed herein. In some examples, aspects of the operations of 1010 may be performed by a buffer allocation component 525 as described with reference to FIG. 5.

At 1015, the method may include generating using a library associated with the first programming language an interface for accessing, via the virtual machine, the at least one memory buffer, the interface associated with the first programming language that is also associated with the virtual machine and accessible via memory associated with the virtual machine The operations of 1015 may be performed in accordance with examples as disclosed herein. In some examples, aspects of the operations of 1015 may be performed by an interface generation component 530 as described with reference to FIG. 5.

At 1020, the method may include performing, using the interface and the first programming language that is associated with the virtual machine, a zero-copy read of data from or a zero-copy write of data to the file system server that is associated with the second programming language. The operations of 1025 may be performed in accordance with examples as disclosed herein. In some examples, aspects of the operations of 1025 may be performed by a zero-copy component 535 as described with reference to FIG. 5.

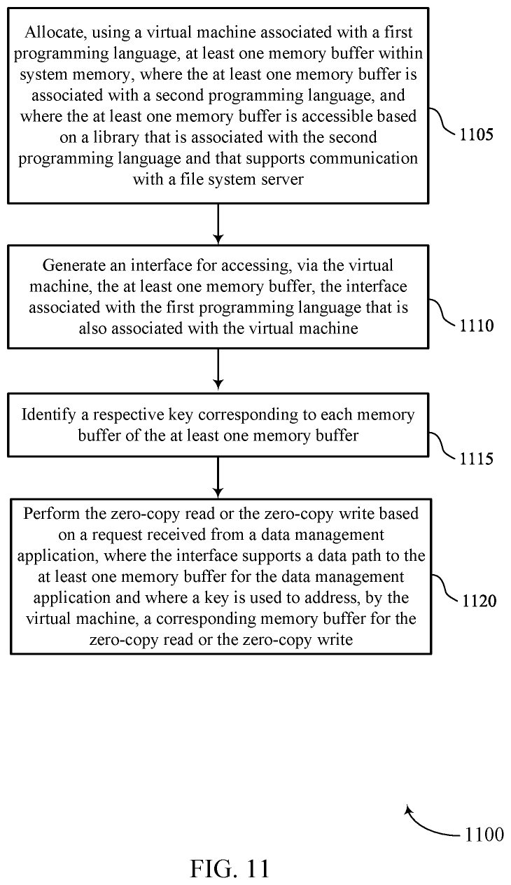

FIG. 11 shows a flowchart illustrating a method 1100 that supports zero-copy concurrent file sharing protocol access from a virtual machine in accordance with aspects of the present disclosure. The operations of the method 1100 may be implemented by a DMS or its components as described herein. For example, the operations of the method 1100 may be performed by a DMS as described with reference to FIGS. 1 through 6. In some examples, a DMS may execute a set of instructions to control the functional elements of the wireless DMS to perform the described functions. Additionally, or alternatively, the wireless DMS may perform aspects of the described functions using special-purpose hardware.

At 1105, the method may include allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server. The operations of 1105 may be performed in accordance with examples as disclosed herein. In some examples, aspects of the operations of 1105 may be performed by a buffer allocation component 525 as described with reference to FIG. 5.

At 1110, the method may include generating an interface for accessing, via the virtual machine, the at least one memory buffer, the interface associated with the first programming language that is also associated with the virtual machine. The operations of 1110 may be performed in accordance with examples as disclosed herein. In some examples, aspects of the operations of 1110 may be performed by an interface generation component 530 as described with reference to FIG. 5.

At 1115, the method may include identifying a respective key corresponding to each memory buffer of the at least one memory buffer. The operations of 1115 may be performed in accordance with examples as disclosed herein. In some examples, aspects of the operations of 1115 may be performed by a key mapping component 560 as described with reference to FIG. 5.

At 1120, the method may include the method may include performing the zero-copy read or the zero-copy write based on a request received from a data management application, where the interface supports a data path to the at least one memory buffer for the data management application and where a key is used to address, by the virtual machine, a corresponding memory buffer for the zero-copy read or the zero-copy write. The operations of 1115 may be performed in accordance with examples as disclosed herein. In some examples, aspects of the operations of 1115 may be performed by an application interface 555 as described with reference to FIG. 5.

A method for data management is described. The method may include allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server, generating an interface for accessing, via the virtual machine, the at least one memory buffer, the interface associated with the first programming language that is also associated with the virtual machine, and performing, using the interface and the first programming language that is associated with the virtual machine, a zero-copy read of data from or a zero-copy write of data to the file system server that is associated with the second programming language.

An apparatus for data management is described. The apparatus may include at least one processor, memory coupled with the at least one processor, and instructions stored in the memory. The instructions may be executable by the at least one processor to cause the apparatus to allocate, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server, generate an interface for accessing, via the virtual machine, the at least one memory buffer, the interface associated with the first programming language that is also associated with the virtual machine, and perform, using the interface and the first programming language that is associated with the virtual machine, a zero-copy read of data from or a zero-copy write of data to the file system server that is associated with the second programming language.

Another apparatus for data management is described. The apparatus may include means for allocating, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server, means for generating an interface for accessing, via the virtual machine, the at least one memory buffer, the interface associated with the first programming language that is also associated with the virtual machine, and means for performing, using the interface and the first programming language that is associated with the virtual machine, a zero-copy read of data from or a zero-copy write of data to the file system server that is associated with the second programming language.

A non-transitory computer-readable medium storing code for data management is described. The code may include instructions executable by a processor to allocate, using a virtual machine associated with a first programming language, at least one memory buffer within system memory, where the at least one memory buffer is associated with a second programming language, and where the at least one memory buffer is accessible based on a library that is associated with the second programming language and that supports communication with a file system server, generate an interface for accessing, via the virtual machine, the at least one memory buffer, the interface associated with the first programming language that is also associated with the virtual machine, and perform, using the interface and the first programming language that is associated with the virtual machine, a zero-copy read of data from or a zero-copy write of data to the file system server that is associated with the second programming language.

In some examples of the method, apparatuses, and non-transitory computer-readable medium described herein, operations, features, means, or instructions for performing the zero-copy read or the zero-copy write may include operations, features, means, or instructions for reading, in accordance with the zero-copy read and via the virtual machine, the data from the at least one memory buffer without copying the data to another memory location, where the at least one memory buffer may be configured to accept the data from the file system server before the data may be read from the at least one memory buffer.

In some examples of the method, apparatuses, and non-transitory computer-readable medium described herein, operations, features, means, or instructions for performing the zero-copy read or the zero-copy write may include operations, features, means, or instructions for writing, in accordance with the zero-copy write and via the virtual machine. the data to the at least one memory buffer without copying the data to another memory location, where the at least one memory buffer may be configured to make the data available to the file system server after the data may be written to the at least one memory buffer.

In some examples of the method, apparatuses, and non-transitory computer-readable medium described herein, operations, features, means, or instructions for generating the interface may include operations, features, means, or instructions for generating the interface using a library associated with the first programming language, the interface being accessible via memory associated with the virtual machine.

In some examples of the method, apparatuses, and non-transitory computer-readable medium described herein, operations, features, means, or instructions for allocating the at least one memory buffer may include operations, features, means, or instructions for allocating, using the first programming language, the at least one memory buffer outside a memory heap associated with the virtual machine.

In some examples of the method, apparatuses, and non-transitory computer-readable medium described herein, operations, features, means, or instructions for performing the zero-copy read or the zero-copy write may include operations, features, means, or instructions for performing the zero-copy read or the zero-copy write based on a request received from a data management application, where the interface supports a data path to the at least one memory buffer for the data management application.

In some examples of the method, apparatuses, and non-transitory computer-readable medium described herein, the data management application may be an archival application.

In some examples of the method, apparatuses, and non-transitory computer-readable medium described herein, operations, features, means, or instructions for allocating the at least one memory buffer may include operations, features, means, or instructions for identifying a respective key corresponding to each memory buffer of the at least one memory buffer, where a key may be used to address, by the virtual machine, a corresponding memory buffer for the zero-copy read or the zero-copy write.

In some examples of the method, apparatuses, and non-transitory computer-readable medium described herein, each key may be mapped to a respective file system server of a set of multiple file system servers.

In some examples of the method, apparatuses, and non-transitory computer-readable medium described herein, the first programming language may be Java or Scala and the second programming language may be C++.

In some examples of the method, apparatuses, and non-transitory computer-readable medium described herein, the virtual machine may be a Java virtual machine.

In some examples of the method, apparatuses, and non-transitory computer-readable medium described herein, the at least one memory buffer may be configured to be accessed by the file system server based on a server message block (SMB) protocol.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, any quantity of one or more processing units, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
allocating, using a virtual machine associated with a first programming language, at least one memory buffer within system memory, wherein the at least one memory buffer is associated with a second programming language, and wherein the at least one memory buffer is accessible based at least in part on a library that is associated with the second programming language and that supports communication with a file system server;
generating an interface for accessing, via the virtual machine, the at least one memory buffer, the interface associated with the first programming language that is also associated with the virtual machine; and
performing, using the interface and the first programming language that is associated with the virtual machine, a zero-copy read of data from or a zero-copy write of data to the file system server that is associated with the second programming language.

2. The method of claim 1, wherein performing the zero-copy read or the zero-copy write comprises:
reading, in accordance with the zero-copy read and via the virtual machine, the data from the at least one memory buffer without copying the data to another memory location, wherein the at least one memory buffer is configured to accept the data from the file system server before the data is read from the at least one memory buffer.

3. The method of claim 1, wherein performing the zero-copy read or the zero-copy write comprises:
writing, in accordance with the zero-copy write and via the virtual machine, the data to the at least one memory buffer without copying the data to another memory location, wherein the at least one memory buffer is configured to make the data available to the file system server after the data is written to the at least one memory buffer.

4. The method of claim 1, wherein generating the interface comprises:
generating the interface using a library associated with the first programming language, the interface being accessible via memory associated with the virtual machine.

5. The method of claim 1, wherein allocating the at least one memory buffer comprises:
allocating, using the first programming language, the at least one memory buffer outside a memory heap associated with the virtual machine.

6. The method of claim 1, wherein performing the zero-copy read or the zero-copy write comprises:
performing the zero-copy read or the zero-copy write based at least in part on a request received from a data management application, wherein the interface supports a data path to the at least one memory buffer for the data management application.

7. The method of claim 6, wherein the data management application is an archival application.

8. The method of claim 1, wherein allocating the at least one memory buffer comprises:
identifying a respective key corresponding to each memory buffer of the at least one memory buffer, wherein a key is used to address, by the virtual machine, a corresponding memory buffer for the zero-copy read or the zero-copy write. 9 The method of claim 8, wherein each key is mapped to a respective file system server of a plurality of file system servers.

10. The method of claim 1, wherein the first programming language is Java or Scala and the second programming language is C++.

11. The method of claim 1, wherein the virtual machine is a Java virtual machine.

12. The method of claim 1, wherein the at least one memory buffer is configured to be accessed by the file system server based at least in part on a server message block (SMB) protocol.

13. An apparatus for data management, comprising:
at least one processor;
memory coupled with the at least one processor; and
instructions stored in the memory and executable by the at least one processor to cause the apparatus to:
allocate, using a virtual machine associated with a first programming language, at least one memory buffer within system memory, wherein the at least one memory buffer is associated with a second programming language, and wherein the at least one memory buffer is accessible based at least in part on a library that is associated with the second programming language and that supports communication with a file system server;
generate an interface for accessing, via the virtual machine, the at least one memory buffer, the interface associated with the first programming language that is also associated with the virtual machine; and
perform, using the interface and the first programming language that is associated with the virtual machine, a zero-copy read of data from or a zero-copy write of data to the file system server that is associated with the second programming language.

14. The apparatus of claim 13, wherein, to perform the zero-copy read or the zero-copy write, the instructions are executable by the at least one processor to cause the apparatus to:
read, in accordance with the zero-copy read and via the virtual machine, the data from the at least one memory buffer without copying the data to another memory location, wherein the at least one memory buffer is configured to accept the data from the file system server before the data is read from the at least one memory buffer.

15. The apparatus of claim 13, wherein, to perform the zero-copy read or the zero-copy write, the instructions are executable by the at least one processor to cause the apparatus to:
write, in accordance with the zero-copy write and via the virtual machine, the data to the at least one memory buffer without copying the data to another memory location, wherein the at least one memory buffer is configured to make the data available to the file system server after the data is written to the at least one memory buffer.

16. The apparatus of claim 13, wherein, to generate the interface, the instructions are executable by the at least one processor to cause the apparatus to:
generate the interface using a library associated with the first programming language, the interface being accessible via memory associated with the virtual machine.

17. A non-transitory computer-readable medium storing code for data management, the code comprising instructions executable by at least one processor to:
allocate, using a virtual machine associated with a first programming language, at least one memory buffer within system memory, wherein the at least one memory buffer is associated with a second programming language, and wherein the at least one memory buffer is accessible based at least in part on a library that is associated with the second programming language and that supports communication with a file system server;
generate an interface for accessing, via the virtual machine, the at least one memory buffer, the interface associated with the first programming language that is also associated with the virtual machine; and
perform, using the interface and the first programming language that is associated with the virtual machine, a zero-copy read of data from or a zero-copy write of data to the file system server that is associated with the second programming language.

18. The non-transitory computer-readable medium of claim 17, wherein, to perform the zero-copy read or the zero-copy write, the instructions are executable by the at least one processor to:
read, in accordance with the zero-copy read and via the virtual machine, the data from the at least one memory buffer without copying the data to another memory location, wherein the at least one memory buffer is configured to accept the data from the file system server before the data is read from the at least one memory buffer.

19. The non-transitory computer-readable medium of claim 17, wherein, to perform the zero-copy read or the zero-copy write, the instructions are executable by the at least one processor to:
write, in accordance with the zero-copy write and via the virtual machine, the data to the at least one memory buffer without copying the data to another memory location, wherein the at least one memory buffer is configured to make the data available to the file system server after the data is written to the at least one memory buffer.

20. The non-transitory computer-readable medium of claim 17, wherein, to generate the interface, the instructions are executable by the at least one processor to:
generate the interface using a library associated with the first programming language. the interface being accessible via memory associated with the virtual machine.
